(19) United States
(12) Patent Application Publication
(10) Pub. No.: US 2003/0037034 A1
(43) Pub. Date: Feb. 20, 2003

(54) System and method for lubricants supply chain management

(76) Inventors: Tim Daniels, Berkeley, CA (US); Doug Hinzie, Novato, CA (US); David Spatz, Tiburon, CA (US)

Correspondence Address: Timothy J. Hadlock, Chevron Corporation, P.O. Box 6006, San Ramon, CA, 94583-0806, US

(21) Appl. No.: 09/932,571

(22) Filed: Aug. 16, 2001

(51) Int. Cl. G06F 7/00

(52) U.S. Cl. 707/1

(57) ABSTRACT

The invention includes a method of lubricants supply chain management including: storing in a web-accessible database a catalog of lubricants and prices-per-unit for same which prices-per-unit optionally decrease based on certain pre-determined cumulative volume purchases; upon receiving at a web server a request from a web-browser client, querying the database and serving the results of the query to the requesting web-browser client for display; serving an order form to the web-browser client which is configured to contain fields for order quantity and type for lubricants, delivery type preferences and delivery address entered in the web-browser client, and determining and displaying on the web-browser client a delivery price quote; receiving an order from the web-browser client for a specific type and quantity of lubricants and having a specific delivery type selected; electronically transmitting over a network the order to an order fulfillment agent; where the order fulfillment agent electronically transmits over a network the order to at least one lubricant blender; electronically transmitting over a network the order and the delivery information to a freight-handling agent; where the freight-handling agent inputs the information into a delivery optimization system which outputs a delivery schedule which includes the order, and electronically transmits over a network the order and the delivery information to at least one trucking company; and maintaining the status and all actions and communications for the order in a second web-accessible database.

### I. FIELD OF THE INVENTION

This invention relates to system and method system and method for an improved Lubricants supply chain

### II. BACKGROUND OF THE INVENTION

Lubricant products are traditionally sold through wholesale distributors, also known in the industry as “jobbers”. The jobbers have the retail outlet and/or end-user customer contacts, set or negotiate prices and make deliveries. Jobbers sell the lubricants to end-users, retail outlets (e.g., Walmart), or installers (e.g., Jiffy Lube) (collectively “end user” or “end customer”). Jobbers also often also coordinate or act as an intermediary in any customer service that may occur. The result is that the lubricant producer and all but a few large end users have little or no contact.

Jobbers typically carry multiple competing brands and selectively match customer needs with brands. This selection is not necessarily based on the best lubricant for the end-user's application. Instead, the selection may be based on available inventory or maximizing profit for the jobber. Thus, this can mean that the end user may not have access to the lubricant that best suits their particular needs. They may also pay a premium for the lubricant they buy to cover the mark-up cost and profit of the jobber's operation. There are also costs to the lubricants producer associated with maintaining a traditional jobber network. These costs include maintaining a sales staff, incentive programs, marketing, and pricing administration.

In order to eliminate these administrative costs for the lubricants producer, provide direct pricing from the lubricants producer to the end customer, and allow the lubricants producer to control the end customer relationship, a method that facilitates direct sales of lubricants to end customer would be advantageous.

Avoiding these shortcomings of the jobber network system in the past has been difficult. It was impractical for the lubricants producer to have a direct sales team sufficiently large to contact end customers directly. Also, the local delivery of lubricants orders of less than a full truckload was either unavailable or excessively expensive. Instead, the jobbers handled these local customer sales administration and delivery functions.

With the advent of wide adoption of the Internet and other new information technology it is now possible to craft a system and method allowing the lubricants producer to wholly or partially disintermediate the jobber, thus overcoming previous impediments which necessitated the use of jobbers. The system and method of the present invention provides such a direct sales method.

### III. SUMMARY OF THE INVENTION

The invention includes a method of lubricants supply chain management including: storing in a web-accessible database a catalog of lubricants and prices-per-unit for same which prices-per-unit decrease at certain pre-determined quantity points; upon receiving at a web server a request from a web-browser client, querying the database and serving the results of the query to the requesting web-browser client for display; serving one or more order forms to the web-browser client which contain fields or other selection means for order quantity and type for lubricants, delivery type preferences and delivery address entered in the web-browser client, and determining and displaying on the web-browser client a delivery price quote; receiving an order from the web-browser client for a specific type and quantity of lubricants and having a specific delivery type selected; electronically transmitting over a network the order to an order fulfillment agent; where the order fulfillment agent electronically transmits over a network the order to at least one lubricant blender; electronically transmitting over a network the order and the delivery information to a freight-handling agent; where the freight-handling agent inputs the information into a delivery optimization system which outputs a delivery schedule which includes the order, and electronically transmits over a network the order and the delivery information to at least one trucking company; and maintaining the status and all actions and communications for the order in a second web-accessible database.

In other embodiments the invention includes systems configured and adapted to perform the steps listed in the above-described methods, and computer readable media containing computer readable instructions configured and adapted to perform the steps listed in the above-described methods.

These and other features and advantages of the present invention will be made more apparent through a consideration of the following detailed description of a preferred embodiment of the invention. In the course of this description, frequent reference will be made to the attached drawings.

### IV. BRIEF DESCRIPTION OF THE DRAWINGS

FIG. 1 is a schematic block system diagram of one embodiment of the invention.

FIG. 2 is a schematic block entity-relationship diagram depicting, in one embodiment of the invention, the entities participating in the invention and their relationships.

FIG. 3 is a schematic block level 0 flow diagram of one embodiment of the invention.

FIGS. 4A and 4B depict in one embodiment of the invention, schematic diagrams of the Lubricants Ordering step of the method and system of the invention.

FIG. 5 depicts in one embodiment of the invention, a hybrid schematic block diagram combining aspects of an entity-relationship diagram, messages and data passing between the entities and the order of such events.

FIG. 6 depicts in one embodiment of the invention, a conceptual data model for implementing the database aspects of the invention.

### V. DETAILED DESCRIPTION OF PREFERRED EMBODIMENTS

### A. Introduction

The following discussion and figures include a general description of a suitable computing environment in which the invention may be implemented. While the invention will be described in the general context of an application program that runs on an operating system in conjunction with a personal computer, those skilled in the art will recognize that the invention also may be implemented in combination with other program modules. Generally, program modules include routines, programs, components, data structures, etc. that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

Then invention generally relates to a B2B e-commerce business. Basic components of such a business include: all of the software which will create a store operation, a product catalog (where the online customers select what they want to order), a shopping cart (where product selections are collected), and transaction security (e.g., credit authorization).

Referring now to the drawings, in which like numerals represent like elements throughout the several figures, aspects of the present invention and a suitable operating environment will be described.

### B. System

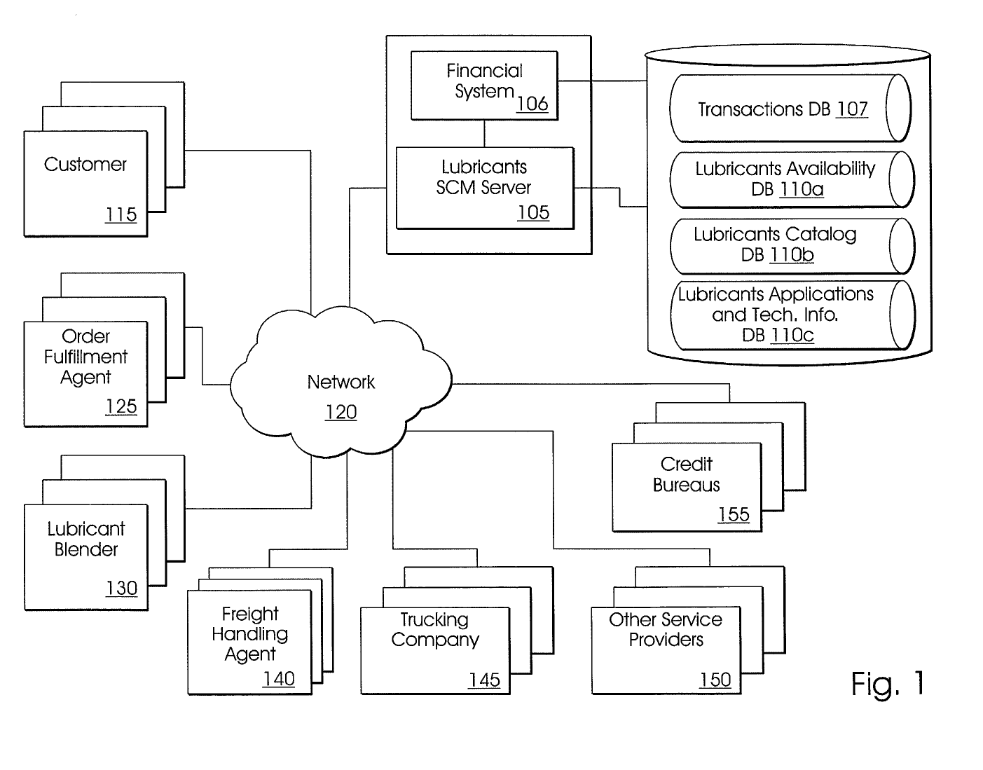

FIG. 1 is a schematic block system diagram of one embodiment of the invention. Each entity involved in the method, in one embodiment, is depicted. The web server for Lubricants Supply Chain Manager 105 (“Lubes SCM”) is connected with Financial System 106, Lubricants Availability DB 110a, Lubricants Catalog DB 110b (“Lubes DB”), Transactions Database 107, and Lubricants Applications and Technical Information DB 110c. Lubes SCM 105, Customer 115, Order Fulfillment Agent 125, Lubricant Blender 130, Freight Handling Agent 140, Trucking Company 145, Other Service Providers 150, and Credit Bureaus 155, are each connected to a Network 120.

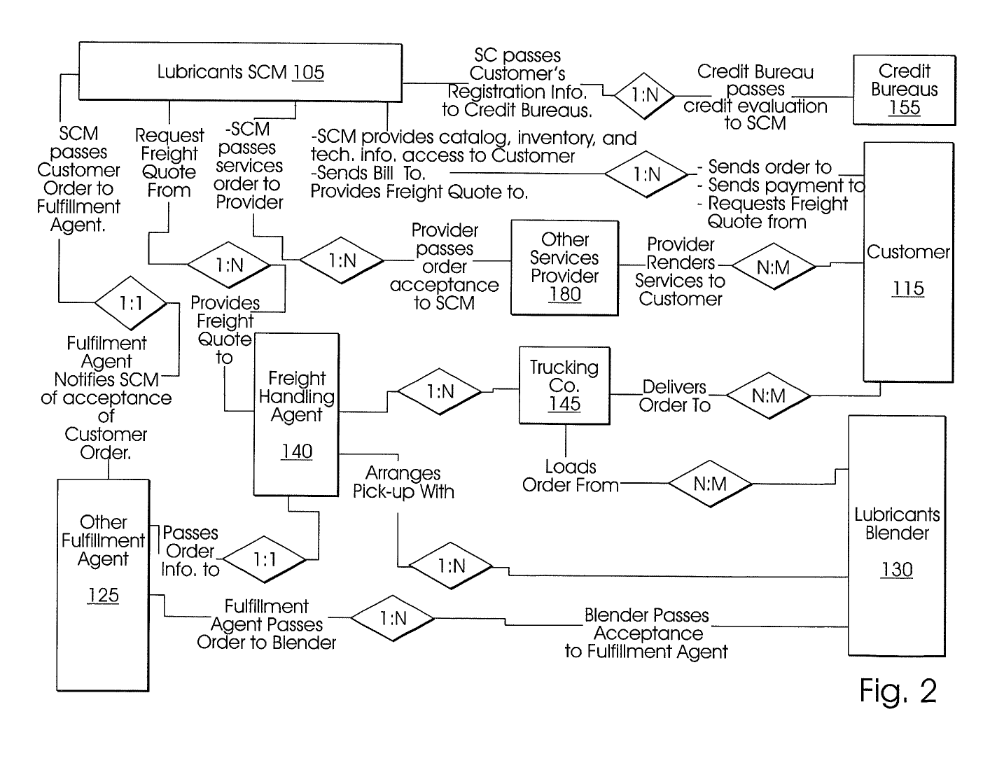

The relationships between these entities are provided in FIG. 2. Network 120 is optionally the Internet or other public or private networks or combinations thereof. The communication of all entities through a common Network 120 is illustrative only, and the invention includes embodiments where some entities communicate through one network, other entities through a different network, and various permutations thereof. That is, the Lubricants SCM Server 105, as well as any general-purpose computers utilized by Customers 115 and other entities (collectively, the “nodes”) preferably transmit digitally encoded data and other information between one another. The communication links between the nodes preferably comprise a cable, fiber or wireless link on which electronic signals can propagate. For example, each node may be connected via an Internet connection using a public switched telephone network (PSTN), such as those provided by a local or regional telephone operating company. Alternatively, each node may be connected by dedicated data lines, cellular, Personal Communication Systems (“PCS”), microwave, or satellite networks.

FIG. 2 is a schematic diagram depicting a conceptual data model/entity-relationship diagram. It shows the key entities of one embodiment of the invention and their interrelationships and key messages transferring between the entities in the practice of the method and system of the invention.

The diagram is described in the context of an example for one embodiment of a method/process according to the invention. One or more Customers 115 view an on-line catalog served by Lubes SCM 105. Customers 115 optionally request a freight price quote on a contemplated order through SCM 105 who communicates the request to Freight Handling Agent 140. Freight Handling Agent 140 processes the request and returns a quote through SCM 105 to Customer 115. Customer 115 then passes an order to Lubes SCM 105. If purchase on credit is requested by Customer 115, then before accepting the order, Lubes SCM 105 passes Customer information to one or more internal or external Credit Bureaus 155 for a credit evaluation.

If the order is accepted, Lubes SCM 105 passes the order to Order Fulfillment Agent 125 and optionally simultaneously to Lubricants Blender 130. Order Fulfillment Agent 125 notifies Lubes SCM 105 of acceptance or rejection of the order. If accepted, Order Fulfillment Agent 125 passes order information to one or more Lubricants Blenders 130, if not previously done by SCM 105, and SCM 105 passes order to Freight Handling Agent 140. Freight Handling Agent 140 processes the order in a delivery schedule optimization system to determine a pick-up and delivery schedule for the order. When determined, the schedule is passed to one or more Trucking Companies 145. One or more Trucking Companies 145 provide pick-up and delivery services from one or more Lubricants Blenders 130 to one or more Customers 115.

Lubricants Blender 130 manufactures the products required for the order and prepares them for shipping. Except where Customer 115 picks up the Lubricants itself, Trucking Companies 145 pick up the products and deliver them to Customer 115. Trucking Companies 145 notifies Freight Handling Agent 140, and optionally Lubes SCM 105 of delivery. Lubes SCM 105 then bills Customer 115 for the order. Customer 115 makes payment to Lubes SCM 105 for the order and the freight charges, or optionally pays freight charges directly to Freight Handling Agent 140 or Trucking Companies 145 (not shown).

Where Customers 115 order services, Lubes SCM 105 passes the order to one or more Other Service Providers 150. One or more Other Service Providers 150 serve one or more Customers 115. Notification of completion of services, and billing and payment is similar to that described above for products.

### D. Method

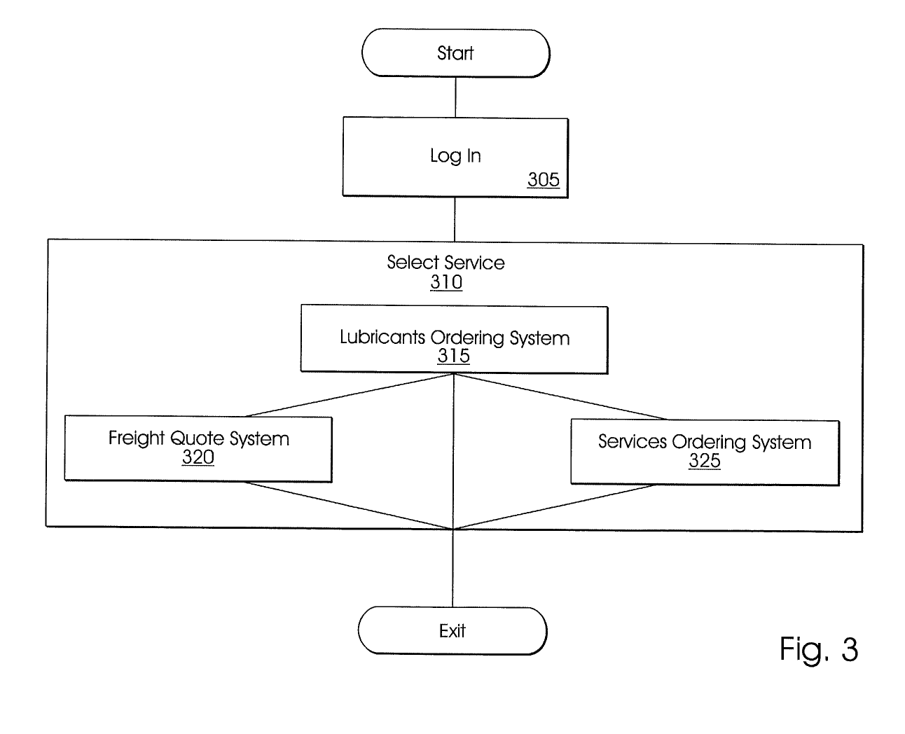

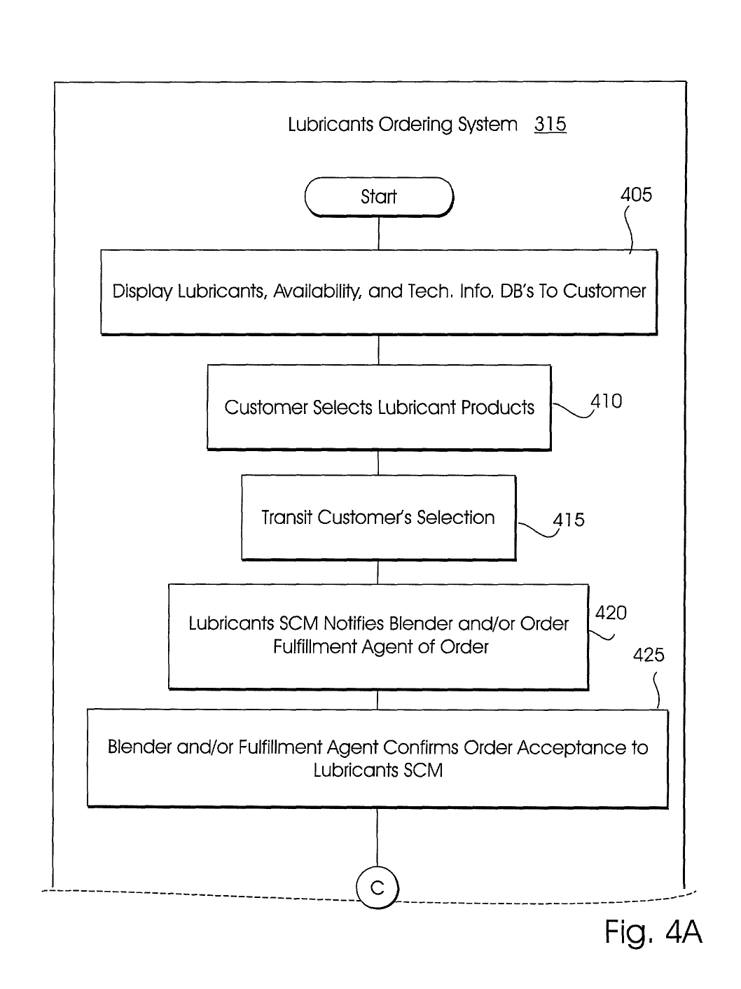

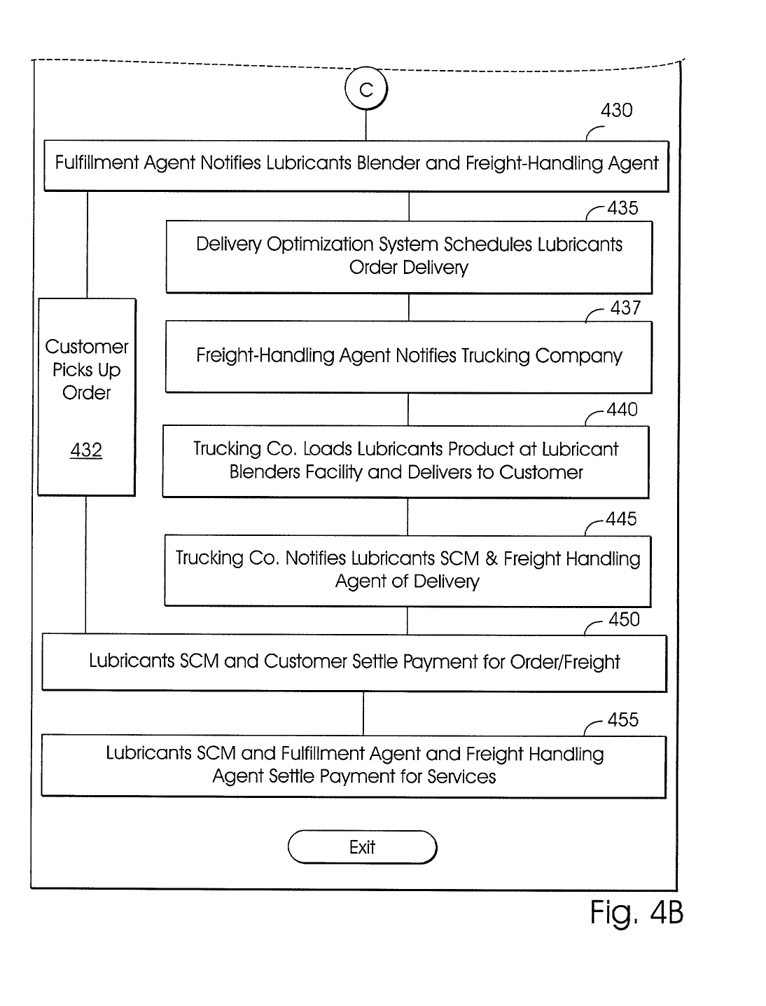

The method/process aspect of the invention is illustrated and described in FIGS. 3 and 4 as a series of process steps. As would be clear to one skilled in the art, the process steps can be embodied as code for a computer program for operation on a conventional programmed digital computer, such as a client (Customer 115) and server (Lubricants SCM Server 105) (each shown in FIG. 1). The program code can be embodied as a computer program on a computer-readable storage medium or as a computer data signal in a carrier wave transmitted over Network 120 (shown in FIG. 1).

FIG. 3 is a schematic block level 0 flow diagram¹ of one embodiment of the invention. Customer 115 (shown in FIG. 2) logs in (step 305) to Lubes SCM 105 web site and selects (step 310) the Lubricants Ordering System 315. Thereafter, the Customer may select the Freight Quote System 320, and/or Service Ordering System 325. Thus, Customer 115 must first enter Lubricants Ordering System 15, before being permitted the option of then entering Freight Quote System or Service Ordering System 325. In an alternate embodiment, each of these systems is integral with and/or accessible from all other services or portions thereof.

Further detail of the log-on procedure 305 follows: Typically the user will begin log on by selecting a button. A log on screen will then be displayed. The content of the log on screen is preformatted except for the user entries which are to be entered in any data input fields. An example of an input field is a userid. After a user has entered in the field an acceptable input, he would then click on a submit button. At this point the Web server captures the information entered by the user. It will be appreciated that the Web server of the Lubricants Ordering System 315 captures the information entered by the user, including specialized input, as well as any “hidden” default information, which can include password authorizations, charge account identification, and other information that can be used by the system responding to the request. Thus the system can assume that the “hidden” password is an authorization to perform some function, such as include information from confidential source, or exit to the Internet. An acknowledgement of successful sign-on is displayed, if successful.

A customer may log on using a typical personal computer system or workstation system. Such a system would include typical components such as a bus for communicating information, and a processor coupled with the bus for processing information, random access memory, coupled to the bus for storing information and instructions to be executed by the processor. RAM also may be used for storing temporary variables or other intermediate information during execution of instructions by the processor, a read only memory coupled to the bus for storing static information and instructions for the processor, and a data storage device coupled to the bus for storing information and instructions. The data storage device may include a magnetic disk or optical disk and its corresponding disk drive can be coupled to the computer system. Also the system may be coupled via the bus to a display device, such as a cathode ray tube, for displaying information to a computer user. The computer system further includes a keyboard and a cursor control, such as a mouse. Any other access devices for accessing a network are intended to be included in the invention. Such devices include properly equipped and configured cellular phones and personal digital assistants.

While the preferred network is the Internet, other networks may be used, preferably capable of transmitting using Transmission Control Protocol/Internet Protocol and Hyper-Text Transfer Protocol. The communication links between the entities for implementing the network preferably comprises a cable, fiber or wireless link on which electronic signals can propagate. For example, each entity may be connected via an Internet connection using a public switched telephone network such as those provided by a local or regional telephone operating company. Alternatively, each entity may be connected by dedicated data lines, cellular, Personal Communication Systems, microwave, or satellite networks.

FIG. 4 depicts in one embodiment a schematic diagram of Lubricants Ordering step 315 of the process. The initial step is to Display Lubricants Catalog To Customer (step 405). From this display, Customer 115 selects Lubricants Products (step 410). This step optionally includes also selecting offered services, credit request, freight type, and other options. Customer 115 then transmits such selections to the Lubes SCM 105 (step 415). Upon receiving the order (and optionally approving credit and/or accepting the order), Lubes SCM 105 passes the order information to Order Fulfillment Agent 125 (step 420).

Order Fulfillment Agent 125 notifies Lubes SCM 105 of order acceptance (step 425) and then SCM 105 passes the order information to Freight Handling Agent 140 (step 430). Passing the order information to Freight Handling Agent 140 is optional since the Customer may opt to pick up the order directly (step 432) rather than pay for delivery. If the Customer chooses delivery, then Freight Handling Agent 140 enters the order information into a scheduling application, which returns a pick-up and deliver schedule for the order (step 435). This step allows efficient and economical use of trucking space since otherwise delivery of partial truckloads would be impracticable. The scheduling application overcomes this by combining partial loads and otherwise managing multiple pick-ups and deliveries to optimize the schedule, e.g., least distance traveled, most full trucks, least expensive route. Such scheduling systems are available commercially from i2 Technologies located at One i2 Place, 11701 Luna Road, Dallas, Tex. 75234 USA, and as described in more detail at its website, http://www.i2.com.

The ability of the Freight Handling Agent 140 to combine multiple orders from multiple manufacturers of multiple products in a delivery schedule optimization system overcomes in part the prior impracticality of the lubricants producer arranging delivery of partial truck loads of packaged lubricants. A full truckload may be formed from a variety of partial truckloads of products from different industries, e.g., lubricants, automobile parts, and consumer commodities. Such delivery schedule optimization systems are available commercially (e.g., from I2 Technologies as noted above) and/or can be created by those skilled in the art. Often such systems employee genetic algorithms for computing multiple variations of pick-up and delivery schedules, test each schedule against a fitness-factor, e.g., fewest total miles or lowest cost or maximum profit, use the top rating schedules to form new schedules, re-rank those schedules, and so forth until a sufficiently satisfactory schedule is determined.

Thus, genetic algorithms attempt to simulate natural selection by selecting the most fit schedules from which to produce new schedules (offspring). Typically several generations of schedules may be produced before one meets the termination criteria. Genetic algorithms are described in U.S. Pat. No. 6,182,057 entitled Device, Method, And Program Storage Medium For Executing Genetic Algorithm, which is incorporated herein by reference in its entirety. Non-patent information includes, e.g., Introduction to Genetic Algorithms, (see http://lancet.mit.edu/˜mbwall/presentations/lntroToGAs/). Commercially available genetic algorithm programs include Gene Hunter™ from Ward Systems Group Inc. (see hftp://wardsystems.com).

Preferably the order page presented to the Customer 115 includes a truck graphic which shows various truck load states. For example, the first state of the graphic is empty, the second state less than 35 percent full, the third state between 35 and 95 percent full, and the fourth state greater than 95 percent full. These states preferably are graphically presented, e.g., via increasing the amount of dark or hatched space proportional to the white space, the hatched space indicating the loaded portion of the truck and the white space indicating the empty portion of the truck.

A separate message may be presented next to each state informing the Customer 115 of the freight cost efficiency of the order, i.e., freight cost per unit or per unit of weight. The efficiency would improve as the truck filled up. In practice, a one-third or one-half full truck might be charged the same price as a full truck. Once the full truckload freight rate is reached, Customer 115 would see freight cost efficiency increase as additional products are ordered, as additional units would not increase freight costs.

Freight Handling Agent 140 then passed the order and schedule information to Trucking Companies 145 (step 437). Trucking Companies 145 loads the products specified in the order at the Lubricants Blender's 130 facility and deliver it to Customer 115 (step 440). Trucking Companies 145 notifies Freight Handling Agent 140 and optionally Lubes SCM 105 of the completed delivery (step 445). Lubes SCM 105 settles the order with Customer 115 (step 450). This is by various alternate methods, e.g., by billing the Customer 115 and then receiving payment or by other agreed upon methods, including credit card, electronic payment, or other existing or future developed account settlement means.

Since the purchaser-specific order information contains sensitive information (e.g., a credit card number), both vendors and purchasers want to ensure the security of such information. Security is a concern because information transmitted over the Internet may pass through various intermediate computer systems on its way to its final destination. The information could be intercepted by an unscrupulous person at an intermediate system. To help ensure the security of the sensitive information, various encryption techniques are used when transmitting such information between a client computer system and a server computer system. Even though such encrypted information can be intercepted, because the information is encrypted, it is generally useless to the interceptor.

Along the way, the output can be coupled to an auxiliary function, such as back-up or accounting processes (e.g., Financial System 106 and Transaction database 107 per FIG. 1) which allow for service charges for services and items requested. These processes will make use of hidden variables associated with the request, such as charge authorization, one of the hidden variables which may be associated with a request is a credit card number. The credit card number, is preferably encrypted, with a DES or RSA encryption utility, and this along with access authorization variables, will allow access to sensitive databases which reside behind firewalls. If selected data according to the request is permitted to the access authorized user at the location side or outside the Internet, the data can be included in the results reported by the system to the web browser.

The selection of the various items from the electronic catalogs is generally based on the “shopping cart” model. When the purchaser selects an item from the electronic catalog, the server computer system metaphorically adds that item to a shopping cart. When the purchaser is done selecting items, then all the items in the shopping cart are “checked out” (i.e., ordered) when the purchaser provides billing and shipment information. In some models, when a purchaser selects any one item, then that item is “checked out” by automatically prompting the user for the billing and shipment information.

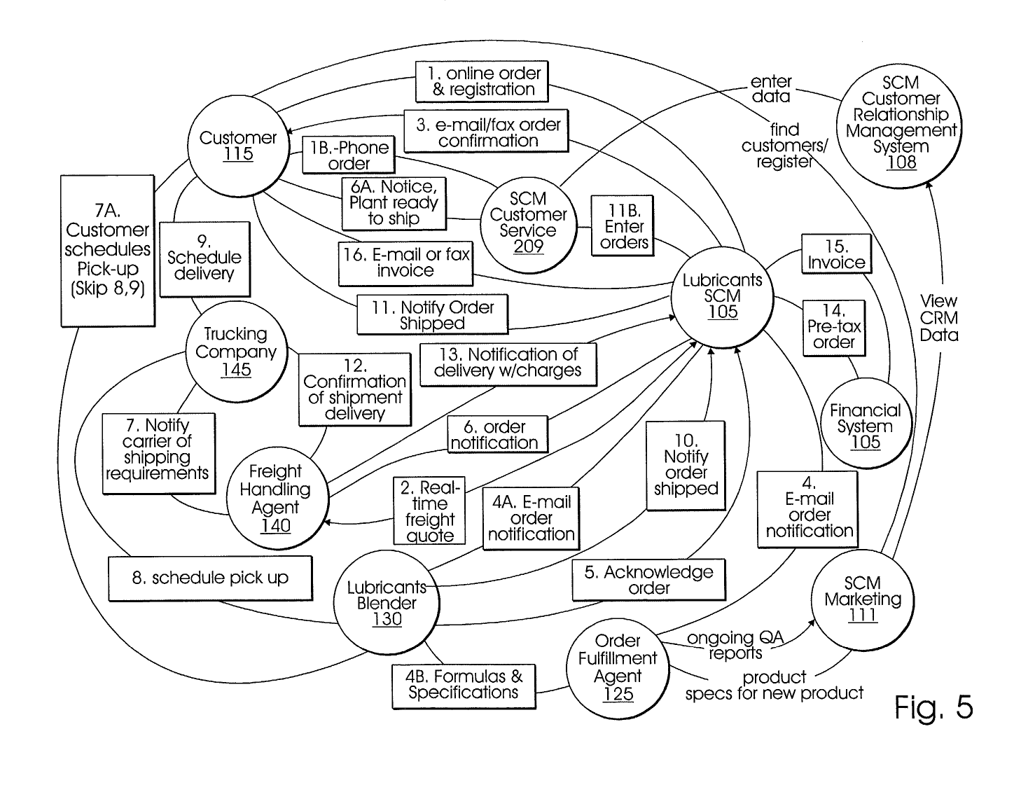

FIG. 5 depicts in one embodiment of the invention, a hybrid schematic block diagram combining aspects of an entity-relationship diagram, messages and data passing between the entities and the order of such events. The circles represent entities involved in the method of the invention. The directed arcs between the circles represent directions of message flows between the entities. The boxes attached to the directed arcs show the nature of the message contents. The message boxes are numbered to show the typical order, in one embodiment, in which the message passing occurs.

In message box 1, a registration and/or order form are passed from Lubricants SCM 105 to Customer 115. The Customer passes an online message for an order back to Lubricants SCM 105 (not shown), or in message box 1 B, passes a order via telephone to Lubricants SCM Customer Service 109. Lubricants SCM 105 obtains real-time freight quote from Freight Handling Agent 140 (message box 2). Lubricants SCM Customer Service 109 enter the order with Lubricants SCM 105 (message box 1.1 B). Lubricants SCM 105 passes an online or telephonic order confirmation to Customer 115 (message box 3).

Lubricants SCM 105 passes order notification to Order Fulfillment Agent 125 and Lubricants Blender 130 (message boxes 4 and 4A). Lubricants Blender 130 obtains Formulas and Specifications as needed from Order Fulfillment Agent 125 (message box 4B). Lubricants Blender 130 passes order acknowledgement to Lubricants SCM 105 (message box 5). Lubricants SCM 105 passes order notification to Freight Handling Agent 140 (message box 6). SCM Customer Service 109 notifies Customer 115 that the order is ready to ship (message box 6A). Freight Handling Agent 140 notifies Trucking Companies 145 of shipping requirements (message box 7). If Customer 115 pick-up order directly, then pick up information is exchanged with Lubricants Blender 130 (message box 7A) and messages 8 and 9 are skipped.

Otherwise, Trucking Companies 145 schedules order pick-up with Lubricants Blender 130 (message box 8). Trucking Companies 145 schedules delivery with Customer 115 (message box 9). Lubricants SCM 105 passes the order shipped message to Customer 115 (message box 11). Trucking Companies 145 sends delivery confirmation to Freight Handling Agent 140 (message box 12).

Freight Handling Agent 140 passes delivery notification with delivery fees information to Lubricants SCM 105 (message box 13). Lubricants SCM 105 passes pre-tax order data to Financial System 106 (message box 14). Financial System 106 generates and passes invoice for the order to Lubricants SCM 105 (message box 15). Lubricants SCM 105 passes invoice to Customer 115 (message box 16).

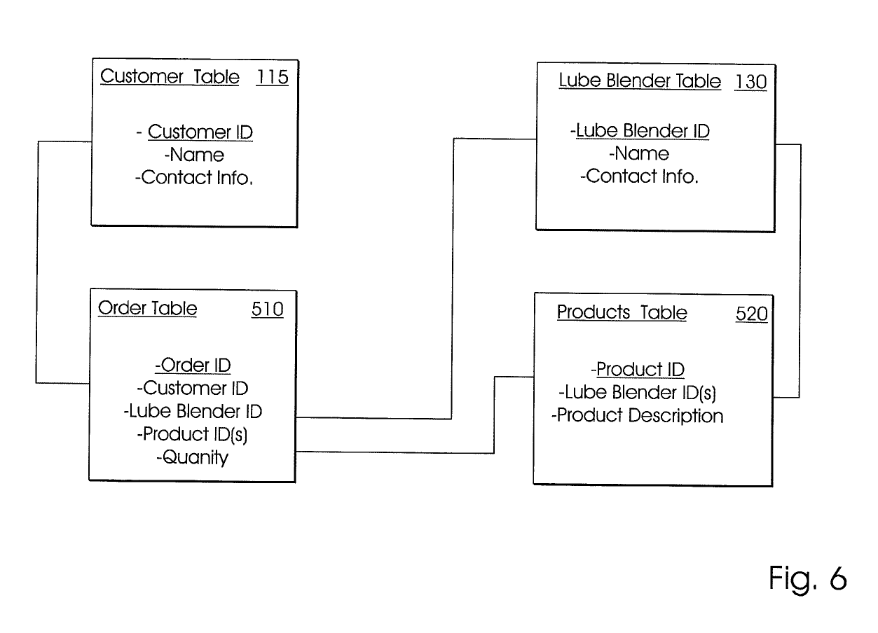

FIG. 6 depicts in one embodiment of the invention, a conceptual data model for implementing databases described herein. This simplified data model depicts exemplary key tables used in implementing the databases required for use of the invention. Customer Table 115 contains customer data such as customer ID, Name and Contact Info. Order Table 510 contains order data such as order ID, Customer ID, Lube Blender ID, Product ID, and quantity. The table optionally is configured to contain multiple Lube Blender ID, Product ID, and quantity attributes.

Lube Blender Table 130 contains information such as Lube Blender ID, name, and contact info. Product Table 520 contains product info, such as Product ID, Lube Blender ID for blenders capable of blending that product, and product descriptions.

Customer ID is the key attribute for Customer Table 115. Customer ID is also the shared attribute linking Customer Table 115 with Order Table 510. Order ID is the key attribute for Order Table 510. The table is linked via shared attributes Lube Blender ID and Product ID with Lube Blender Table 130 and Products Table 520, respectively. Product Table 520 and Lube Blender Tables 130 have Product ID and Lube Blender ID as there respective key attributes. Products Table 520 is linked to Lube Blender Table 130 via shared attribute Lube Blender ID.

FIG. 6 is only one exemplary data model. Modification of the shown tables as well as additional tables, their domains, keys, and links to other tables, and associated queries and reports, and appropriate normalization of each, useful in implementing the databases used in the invention, given the disclosure herein, could be implemented by data base designers of ordinary skill in the art.

### E. Other lmplementation Details

### 1. Terms

The detailed description contained herein is represented partly in terms of processes and symbolic representations of operations by a conventional computer. The processes and operations performed by the computer include the manipulation of signals by a processor and the maintenance of these signals within data packets and data structures resident in one or more media within memory storage devices. Generally, a “data structure” is an organizational scheme applied to data or an object so that specific operations can be performed upon that data or modules of data so that specific relationships are established between organized parts of the data structure.

A “data packet” is type of data structure having one or more related fields, which are collectively defined as a unit of information transmitted from one device or program module to another. Thus, the symbolic representations of operations are the means used by those skilled in the art of computer programming and computer construction to most effectively convey teachings and discoveries to others skilled in the art.

For the purposes of this discussion, a process is generally conceived to be a sequence of computer-executed steps leading to a desired result. These steps generally require physical manipulations of physical quantities. Usually, though not necessarily, these quantities take the form of electrical, magnetic, or optical signals capable of being stored, transferred, combined, compared, or otherwise manipulated. It is conventional for those skilled in the art to refer to representations of these signals as bits, bytes, words, information, data, packets, nodes, numbers, points, entries, objects, images, files or the like. It should be kept in mind, however, that these and similar terms are associated with appropriate physical quantities for computer operations, and that these terms are merely conventional labels applied to physical quantities that exist within and during operation of the computer.

It should be understood that manipulations within the computer are often referred to in terms such as issuing, sending, altering, adding, disabling, determining, comparing, reporting, and the like, which are often associated with manual operations performed by a human operator. The operations described herein are machine operations performed in conjunction with various inputs provided by a human operator or user that interacts with the computer.

### 2. Hardware

It should be understood that the programs, processes, methods, etc. described herein are not related or limited to any particular computer or apparatus, nor are they related or limited to any particular communication architecture. Rather, various types of general purpose machines may be used with program modules constructed in accordance with the teachings described herein. Similarly, it may prove advantageous to construct a specialized apparatus to perform the method steps described herein by way of dedicated computer systems in a specific network architecture with hard-wired logic or programs stored in nonvolatile memory, such as read only memory.

### 3. Program

In the preferred embodiment, the steps of the present invention are embodied in machine-executable instructions. The instructions can be used to cause a general-purpose or special-purpose processor which is programmed with the instructions to perform the steps of the present invention. Alternatively, the steps of the present invention might be performed by specific hardware components that contain hardwired logic for performing the steps, or by any combination of programmed computer components and custom hardware components.

The foregoing system may be conveniently implemented in a program or program module(s) that is based upon the diagrams and descriptions in this specification. No particular programming language has been required for carrying out the various procedures described above because it is considered that the operations, steps, and procedures described above and illustrated in the accompanying drawings are sufficiently disclosed to permit one of ordinary skill in the art to practice the present invention.

Moreover, there are many computers, computer languages, and operating systems which may be used in practicing the present invention and therefore no detailed computer program could be provided which would be applicable to all of these many different systems. Each user of a particular computer will be aware of the language and tools which are most useful for that user's needs and purposes.

The invention thus can be implemented by programmers of ordinary skill in the art without undue experimentation after understanding the description herein.

### 4. Product

The present invention may be provided as a computer program product which may include a machine-readable medium having stored thereon instructions which may be used to program a computer (or other electronic devices) to perform a process according to the present invention. The machine-readable medium may include, but is not limited to, floppy diskettes, optical disks, CD-ROMs, and magneto-optical disks, ROMs, RAMs, EPROMs, EEPROMs, magnet or optical cards, or other type of media/machine-readable medium suitable for storing electronic instructions. Moreover, the present invention may also be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection).

### 5. Components

The major components (also interchangeably called aspects, subsystems, modules, functions, services) of the system and method of the invention, and examples of advantages they provide, are described herein with reference to the figures. For figures including process/means blocks, each block, separately or in combination, is alternatively computer implemented, computer assisted, and/or human implemented. Computer implementation optionally includes one or more conventional general purpose computers having a processor, memory, storage, input devices, output devices and/or conventional networking devices, protocols, and/or conventional client-server hardware and software. Where any block or combination of blocks is computer implemented, it is done optionally by conventional means, whereby one skilled in the art of computer implementation could utilize conventional algorithms, components, and devices to implement the requirements and design of the invention provided herein. However, the invention also includes any new, unconventional implementation means.

### 6. Web Design

Any web site aspects/implementations of the system include conventional web site development considerations known to experienced web site developers. Such considerations include content, content clearing, presentation of content, architecture, database linking, external web site linking, number of pages, overall size and storage requirements, maintainability, access speed, use of graphics, choice of metatags to facilitate hits, privacy considerations, and disclaimers.

### 7. Other Implementations

Other embodiments of the present invention and its individual components will become readily apparent to those skilled in the art from the foregoing detailed description. As will be realized, the invention is capable of other and different embodiments, and its several details are capable of modifications in various obvious respects, all without departing from the spirit and the scope of the present invention. Accordingly, the drawings and detailed description are to be regarded as illustrative in nature and not as restrictive. It is therefore not intended that the invention be limited except as indicated by the appended claims.

VI. What is claimed is:

1. A computer programmed to execute a process for lubricants supply chain management, said process comprising:
(a) upon receiving a request from a web-browser client, querying a database comprising a catalog of lubricants and prices and availability for same and serving said results of said query to said requesting web-browser client for display;
(b) serving an order form to said web-browser client which is configured to contain fields for order quantity and type for lubricants, delivery type preferences and delivery address entered in said web-browser client, and determining and displaying on said web-browser client a delivery price quote;
(c) receiving an order from said web-browser client for a specific type and quantity of lubricants and having a specific delivery type selected;
(d) electronically transmitting over a network said order to a fulfillment agent selected from the group consisting of a Lubricant Blender or an Order Fulfillment Agent, and mixtures thereof;
(e) electronically transmitting over a network said order and said delivery information to a Freight-Handling Agent;
(f) wherein said Freight-Handling Agent inputs said information into a delivery optimization system which outputs a delivery schedule which includes said order, and electronically transmits over a network said order and said delivery information to at least one Trucking Company; and
(g) maintaining the status and all actions and communications for said order in a web-accessible database.

2. The computer of claim 1, wherein said fulfillment agent is an Order Fulfillment Agent and said Order Fulfillment Agent electronically transmits over a network said order to at least one Lubricant Blender.

3. The computer of claim 1, which further comprising serving a product search page to said web browser client, wherein said search page comprising fields supporting alternate search methods selected from the group consisting of product name, product application, cross-applications, and mixtures thereof.

4. The computer of claim 1, which further comprises receiving an order from said web-browser client for a specific type of service selected from the group of empty drum pick-up, lubricant analysis, used lubricant pick-up, and mixtures thereof, and electronically transmitting over a network said order to an service order fulfillment agent.

5. The computer of claim 1, wherein the prices decrease based on cumulative purchase volume over a pre-determined time period.

6. A computer readable medium having computer readable program means embodied thereon for lubricants supply chain management, said computer readable program means comprising:
(a) computer readable program code means for receiving a request from a web-browser client, querying a database comprising a catalog of lubricants and prices and availability for same and serving said results of said query to said requesting web-browser client for display;
(b) computer readable program code means for serving an order form to said web-browser client which is configured to contain fields for order quantity and type for lubricants, delivery type preferences and delivery address entered in said web-browser client, and determining and displaying on said web-browser client a delivery price quote;
(c) computer readable program code means for receiving an order from said web-browser client for a specific type and quantity of lubricants and having a specific delivery type selected;
(d) computer readable program code means for electronically transmitting over a network said order to a fulfillment agent selected from the group consisting of a Lubricants Blender or an Order Fulfillment Agent, and mixtures thereof;
(e) computer readable program code means for electronically transmitting over a network said order and said delivery information to a Freight-Handling Agent;
(f) computer readable program code means for maintaining the status and all actions and communications for said order in a database.

7. The computer readable medium of claim 6 wherein in said computer readable program code means (d) said fulfillment agent order is an order fulfillment agent and said order fulfillment agent electronically transmits over a network said order and blending specifications to at least one lubricant blender.

8. The computer readable medium of claim 6, further comprising computer readable program code means for serving a product search page to said web browser client, wherein said search page comprising fields supporting alternate search methods selected from the group consisting of product name, product application, cross-applications, and mixtures thereof.

9. The computer readable medium of claim 6 further comprising computer readable program code means for receiving an order from said web-browser client for a specific type of service selected from the group of empty drum pick-up, lubricant analysis, used lubricant pick-up, and mixtures thereof, and electronically transmitting over a network said order to an service order fulfillment agent.

10. The computer readable medium of claim 6, wherein in computer readable program code means (a) the prices decrease based on cumulative purchase volume over a pre-determined time period.

11. A method for lubricants supply chain management comprising:
(a) storing in a web-accessible database a catalog of lubricants and prices-per-unit and availability for same which prices-per-unit decrease based on certain pre-determined criteria;
(b) upon receiving at a web server a request from a web-browser client, querying said database and serving said results of said query to said requesting web-browser client for display;
(c) serving an order form to said web-browser client which is configured to contain fields for order quantity and type for lubricants, delivery type preferences and delivery address entered in said web-browser client, and determining and displaying on said web-browser client a delivery price quote;
(d) receiving an order from said web-browser client for a specific type and quantity of lubricants and having a specific delivery type selected;
(e) electronically transmitting over a network said order to an order fulfillment agent;
(f) wherein said order fulfillment agent electronically transmits over a network said order and blending specifications to at least one lubricant blender;
(g) electronically transmitting over a network said order and said delivery information to a freight-handling agent;
(h) wherein said freight-handling agent inputs said information into a delivery optimization system which outputs a delivery schedule which includes said order, and electronically transmits over a network said order and said delivery information to at least one trucking company; and
(i) maintaining the status and all actions and communications for said order in a second web-accessible database.

12. The method of claim 11 further comprising receiving an order from said web-browser client for a specific type of service selected from the group of empty drum pick-up, lubricant analysis, used lubricant pick-up, and mixtures thereof, and electronically transmitting over a network said order to an service order fulfillment agent.

13. The method of claim 11, wherein the pre-determined criteria at which prices-per-unit decreases is cumulative purchase volume over a predetermined time period.
